(19) United States
(12) Patent Application Publication
(10) Pub. No.: US 2008/0044042 A1
(43) Pub. Date: Feb. 21, 2008

(54) Sonic transducer

(76) Inventors: Wei Jia Liu, Beijing (CN); Xinhua Wang, Beijing (CN)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/506,593

(22) Filed: Aug. 18, 2006

(51) Int. Cl. H04R 25/00; H04R 17/00

(52) U.S. Cl. 381/150

(57) ABSTRACT

The present invention provides a sonic transducer comprising an outer shell, a permanent magnet disposed within the outer shell, an electromagnet disposed within the outer shell, a coil for carrying an electrical current, wherein the coil is wrapped around the electromagnet to induce vibration in the electromagnet, and an energy channeler for channeling vibration energy from the electromagnet onto a surface that is in contact with the sonic transducer, whereby the surface becomes a surface sound source that increases the effective range of the sonic transducer.

### FIELD OF THE INVENTION

The present invention relates generally to sound equipment and, more particularly, to a sonic transducer comprising a vibrating source that employs a suitable surface to act as a soundboard for generating audible sound, whereby the surface becomes a surface sound source that increases the effective range of the sonic transducer.

### BACKGROUND OF THE INVENTION

In a conventional speaker, an electromagnet is positioned in a constant magnetic field created by a permanent magnet. The electromagnet and the permanent magnet interact with each other in a typical fashion in that the positive end of the electromagnet is attracted to the negative pole of the permanent magnetic field, and the negative pole of the electromagnet is repelled by the permanent magnet's negative pole. When the electromagnet's polar orientation switches, so does the direction of repulsion and attraction. In this way, the alternating current constantly reverses the magnetic forces between the coil and the permanent magnet, thereby pushing the coil back and forth rapidly similar to a piston.

When the electrical current flowing through the coil changes direction, the coil's polar orientation reverses. This changes the magnetic forces between the coil and the permanent magnet, thus moving the coil and attached diaphragm back and forth. When the coil moves, it pushes and pulls on the speaker cone, which vibrates the air in front of the speaker, creating sound waves. The electrical audio signal can also be interpreted as a wave having a frequency and amplitude that represents the original sound wave and dictates the rate and distance that the coil moves. This determines the frequency and amplitude of the sound waves produced by the diaphragm.

In a conventional point sound source such as a speaker, sound is emitted from the speaker and eradiated to the surrounding environment. Those that are located within an effective range of the speaker hear the sounds directly from the speaker. By contrast, when using a surface sound source such as a vibrating pane of glass, the entire surface is vibrated such that those located within the effective range of the device hears sounds emanating from the surface (surface sound source). In this manner, a surface sound source may be used to enhance the effective range.

A notable disadvantage of point sound sources is that attenuation is much greater because sound produced by a point sound source generally moves forward in a single direction with a certain radiation figure. While the point sound source may be heard loudly and clearly by those that are located directly in front of the point sound source, those that are not located directly in front of the point sound source will not hear the speaker with the same loudness and clarity due to attenuation. Surface sound sources do not function in this manner. Another disadvantage of point sound sources concerns directivity, in that it is easy to tell from which direction the sound is emanating from the point sound source such that the location of the point sound source is obvious to those located with its effective range.

### SUMMARY OF THE INVENTION

In view of the foregoing, it is an object of the present invention to provide sound equipment comprising a sonic transducer that does not require the use of a diaphragm for vibrating air to produce sound that is audible to human ears. Whereas conventional speakers include a diaphragm that vibrates the surrounding air to produce audible sounds, the sonic transducer of the present invention is a vibrating source that employs a suitable surface to acts as a soundboard for generating audible sound. In this manner, the surface functions as a surface sound source (rather than a point sound source), wherein the surface acts as a surface sound source that increases the effective range of the sonic transducer.

One aspect of the invention involves a sonic transducer comprising a outer shell, a permanent magnet disposed within the housing, an electromagnet disposed within the housing, a coil for carrying an electrical current, wherein the coil is wrapped around the electromagnet to induce vibration in the electromagnet, and an energy channeler for channeling vibration energy from the electromagnet onto a surface that is in contact with the sonic transducer. In some embodiments, the housing comprises a weighted outer core to cause the housing to be closely adhered to the horizontally disposed surface during operation. The sonic transducer may further comprise a protective pad attached to a bottom surface of the housing to prevent scratching of the surface during operation. The sonic transducer is powered using an alternating current that induces vibration in the electromagnet, wherein the vibration energy in the electromagnet is channeled onto the surface via the energy channeler. According to the invention, the sonic transducer may further comprise a protective pad disposed between the permanent magnet and the electromagnet to prevent contact therebetween.

In operation, an electrical field generated in the coil causes mechanical changes in the material that make up the electromagnet, wherein the mechanical changes comprise expansion, compression and strain. The electromagnet may comprise piezoelectric materials, piezomagnetic materials, electrostrictive materials, and/or magnetostrictive materials. According to a preferred implementation, the electromagnet comprises a high magnetostrictive material having an alloy core including one or more Rare Earth materials. The surface comprises a table, glass or wall that provides suitable sound transmission characteristics. For example, the surface may comprise wood or glass. According to one embodiment of the invention, the sonic transducer is used in conjunction with a telephony system to form an office conference call system. According to a further embodiment the surface in contact with the sonic transducer comprises a vertically disposed surface, and the sonic transducer is attached to one side of the vertically disposed surface such that sound may be broadcast on both sides of the vertically disposed surface simultaneously. By way of example, the vertically disposed surface may comprise a pane of glass.

Another aspect of the invention involves a sound system, comprising a sound source, an amplifier, a power outlet and a sonic transducer, wherein the sonic transducer comprises a housing, a permanent magnet disposed within the housing, an electromagnet disposed within the housing, a coil for carrying an electrical current, wherein the coil is wrapped around the electromagnet to induce vibration in the electromagnet and an energy channeler for channeling vibration energy from the electromagnet onto a surface that is in contact with the sonic transducer. The sound source, amplifier, sonic transducer and power outlet may be interconnected wirelessly, or by employing conventional electrical wiring. In accordance with the principles of the invention, the sound source may comprise a computer, a DVD player, a CD player, an MP3 player or an FM receiver. Similar to previous embodiments, the sonic transducer broadcasts sound by causing the surface which it is in contact with to vibrate, producing audible sounds such as music. According to additional embodiments of the invention, the device may further comprise an internal amplifier, a wireless transmitter/receiver with microphone, and a telephone set.

Other features and advantages of the present invention should become apparent from the following description of the preferred embodiments, taken in conjunction with the accompanying drawings, which illustrate, by way of example, the principles of the invention.

### BRIEF DESCRIPTION OF THE DRAWINGS

Embodiments of the present invention will now be described, by way of example only, with reference to the following drawings, in which:

FIG. 1 illustrates a cross-sectional view of a preferred sonic transducer constructed in accordance with the principles of the invention;

FIG. 2 illustrates a schematic diagram of a sound system that includes the sonic transducer of FIG. 1;

FIGS. 3A illustrates a side view of an exemplary embodiment of the invention, wherein the sonic transducer of FIG. 1 is located on the top surface of a table, and FIG. 3B illustrates a side view of an exemplary embodiment of the invention, wherein the sonic transducer of FIG. 1 is attached to a vertically disposed surface such as a pane of glass;

FIG. 4 illustrates a schematic diagram of a preferred sound system of the invention, including the sonic transducer of FIG. 1;

FIG. 5 is perspective view illustrating the preferred sound system of FIG. 4;

FIG. 6 is functional diagram of a basic sound system configuration, according to the principles of the invention;

FIG. 7 is functional diagram of a high type sound system configuration; and

FIG. 8 is functional diagram of a conference call system configuration.

### DETAILED DESCRIPTION OF THE PREFERRED EMBODIMENTS

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention is directed to sound equipment comprising a sonic transducer that is distinguishable from a conventional speaker in that it does not require the use of a diaphragm for vibrating air to produce sound that is audible to human ears. More particularly, conventional speakers include an electromagnet and a permanent magnet that interact wherein an alternating current constantly reverses the magnetic forces between a coil and the permanent magnet, thereby pushing the coil back and forth rapidly. The vibration of the coil transfers the force to the diaphragm, which vibrates the surrounding air to produce audible sounds. By contrast, the sonic transducer of the present invention is a vibrating source rather than a speaker that generates audible sound.

A conventional speaker is a “point” sound source with a certain sound radiation field, whereby sound is emitted from the speaker and eradiated to the surrounding environment. People that are located within the effective range of the speaker hear the sounds directly from the speaker. In contrast, the sonic transducer of the invention is employed to vibrate an entire surface such as a wall, a glass pane or a table such that people located within the effective range of the device will hear sounds emanating from the surface (surface sound source). During operation, the sonic transducer vibrates the entire surface, thus vastly enhancing the effective range of the sonic transducer.

One distinction between point sound sources and surface sound sources is that attenuation is much greater with a point sound source. On one hand, a point sound source generally produces sound moving forward in a single direction with a certain radiation figure. While the point sound source may be heard loudly and clearly by those that are located directly in front of the point sound source, those that are located at the sides of the speaker, or at the periphery of the speakers limited effective range, or otherwise not located directly in front of the speaker, will not hear the speaker with the same loudness and clarity due to attenuation. On the other hand, surface sound sources do not function in this manner. For example, if the surface sound source comprises a wall of a room, audible sound is emitted roughly equally from all points of the wall, thereby producing almost identical sounds various locations in the room.

Another distinction between point sound sources and surface sound sources concerns directivity. With regard to point sound sources, it is easy to tell from which direction the sound is emanating such that the location of the point sound source is obvious to those located in the room. However, surface sound sources do not behave in this way. For example, if the sonic transducer of the invention is used to vibrate the wall (which is a suitable vibration medium), it is difficult, if not impossible, for those in the room to determine where the product is located without using their eyes. As a further example, if the sonic transducer is employed to vibrate a large conference table, persons located at different locations (and distances from the sonic transducer) will hear approximately the same sounds. This would not be the case with a point sound source.

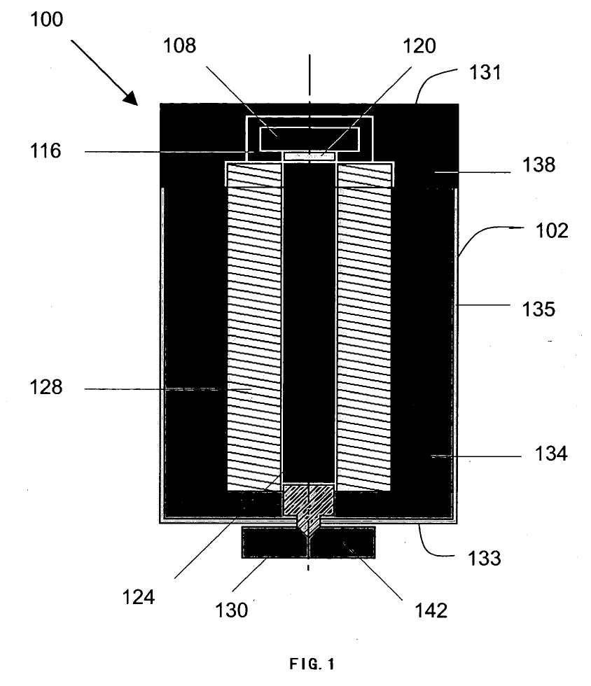

Referring to FIG. 1, a preferred sonic transducer 100 constructed in accordance with the principles of the invention comprises a housing 102, a permanent magnet 108, a permanent magnet stabilizer 116, an electromagnet 124, a coil 128, and an energy channeler 130 for channeling vibration energy from the electromagnet 124 onto a surface or medium that is in contact with the sonic transducer 100. According to the invention, the surface or medium comprises a surface sound source such as a wall, a pane of glass or the top surface of a table. The sonic transducer 100 may further comprise a protective pad 120 disposed between the permanent magnet 108 and the electromagnet 124 to prevent contact therebetween. In the illustrated embodiment, the housing 102 comprises a top surface 131, a bottom surface 133, a weighted outer core 134, an outer shell 135, a cap 138 and a protective pad 142 attached to the bottom surface 133 to prevent scratching of the surface which the sonic transducer 100 is in contact with. The sonic transducer 100 is preferably powered using an alternating current (AC) that induces vibration in the electromagnet 124.

In operation, the sonic transducer 100 may be placed on a horizontally disposed surface of a body such as a table or a sheet of glass, such that the weight of the device causes the protective pad 142 to be closely adhered to the surface, wherein the vibration energy in the electromagnet 124 is channeled onto the surface via the energy channeler 130. More particularly, the outer core 134 of the sonic transducer 100 may be weighted in order to maintain close contact between the protective pad 142 and the surface. The weighted outer core 134 may comprise a magnetic material such as iron that causes the magnetic field to form a loop within the housing 102 and to prevent leakage of the magnetic field, as described hereinbelow. Another suitable material for the weighted outer core 134 comprises steel.

According to the invention, an electrical field generated in the coil 128 acts on the electromagnet 124, which causes mechanical changes in the material(s) that make up the electromagnet 124. Such mechanical changes may comprise expansion, compression and/or strain. By providing an alternating current in the coil 128, the electromagnet 124 is caused to experience vibration strain such as expansion and contraction in rapid concession, thereby inducing vibration in the electromagnet 124 and the other components of the sonic transducer 100 including the housing 102. Suitable materials for the electromagnet 124 include, but are not limited to: (1) piezoelectric materials; (2) piezomagnetic materials; (3) electrostrictive materials; and (4) magnetostrictive materials.

The electromagnet 124 may comprise a high magnetostrictive material having an alloy core including one or more Rare Earth materials. “Rare Earth” is a group name of more than 10 special metal elements (i.e., the Rare Earth Group in the Periodic Table of Elements). High magnetostrictive material is an alloy mainly composed of terbium (Tb), dysprosium (Dy) and pure iron (Fe). It can change electrical energy into mechanical action or vice versa because of its merit as being sensing and actuating material. Demanding only low voltage, the strain it can produce is 40 times higher than that of the traditional magnetostrictive materials. To produce the electromagnet 124, the alloy is mixed with a small amount of high magnetostrictive material, such that it becomes an alloy product having a very high magnetic density, high wearing resistance and high strength. The high magnetostrictive material may comprise without limitation, Rare Earth metal powder, Rare Earth alloy powder, TbDyFe alloy powder, SmFe alloy powder, NdFeB alloy powder, Re—Ni alloy powder, Metal Ca powder, Ti and Ti alloy powder, Ta and Ta alloy powder, and V and V alloy powder. Electromagnets formed with these materials can be used in various areas including sonic applications, ultra-sonic applications, vibration, precision displacement and other areas.

With further reference to FIG. 1, the permanent magnet 108 preferably is chosen to be able to produce a strong magnetic field. By way of example, any of several hard, strong alloys of iron, aluminum, nickel, cobalt, copper, niobium, and tantalum, may be employed to produce suitably strong permanent magnets. Alternatively, the permanent magnet 108 may comprise a conventional permanent magnet having a relatively low magnetic field. However, the use of such a conventional permanent magnet requires a much larger permanent magnet to produce the same magnetic field. As a further alternative, electromagnetic iron may be used as the permanent magnet material. However, this type of magnet is not preferred because it consumes electricity. The housing 102 works to reduce the leakage of the magnetic field produced by the permanent magnet 108. This layer may be manufactured to be very thin (e.g., about 1 mm thick). Suitable material for the outside shell 135 of the housing 102 include metals and plastics. For example, the outer shell 135 may comprise an aluminum alloy having a density of about 2.8.

The permanent magnet stabilizer 116 is designed to be wrapped around the permanent magnet 108. One suitable material for the permanent magnet stabilizer 116 comprises iron. According to other embodiments of the invention that feature a larger sonic transducer, aluminum is the preferred material for the permanent magnet stabilizer 116 due to its ability to regulate the magnetic field to flow upward and downward, and to prevent leakage of the magnetic field. The protective pad 120 is provided between the permanent magnet 108 and the electromagnet 124 to prevent damage in case of a collision between the permanent magnet 108 and the electromagnet 124 during strong vibrations experienced when using a highly amplified sound source. The protective pad 120 may comprise a hard plastic material through which the magnetic field may easily pass.

The electromagnet 124 preferably comprises a material that will deform under an electrical field or a magnetic field, whereby the changes in the electrical or magnetic field result in changes in mechanics (e.g., deformation) of the electromagnet 124. In a preferred implementation, the electromagnet 124 comprises a high magnetostrictive material that will deform under a magnetic field. As set for above, the high magnetostrictive material may comprise: (1) Rare Earth metal powder; (2) Rare Earth alloy powder; (3) TbDyFe alloy powder; (4) SmFe alloy powder; (5) NdFeB alloy powder; (6) Re—Ni alloy powder; (7) Metal Ca powder; (8) Ti and Ti alloy powder; (9) Ta and Ta alloy powder; (10) and V and V alloy powder; (11) combinations thereof; and (12) other high magnetostrictive materials. Additionally, the electromagnet 124 may comprise a paramagnetic material such as iron that has the effect of regulating or control the magnetic field. In particular, the magnetic field is easy to pass thru this material. The energy channeler 130 is employed to form a magnetic path from the electromagnet 124 to the selected surface. For example, the energy channeler 130 may comprise a paramagnetic material such as iron. With a static magnetic field, the permanent magnet 108 establishes a magnetic field such that the magnetic field emits from the bottom of the permanent magnet 108 and passes thru the electromagnet 124 and energy channeler from top to bottom and emerges from the bottom of paramagnetic material. From here, the magnetic field loops around and passes through the surrounding weighted outer core 134 to the top of the housing 102.

During operation of the sonic transducer 100, a user places or fixes the device on a medium. By way of example, the medium may comprise the surface of a table, glass or wall that provides suitable sound transmission characteristics. According to the invention, wood and glass are the preferred surface materials because their inherent density levels result in excellent sound transmission. On the other hand, higher density materials such as steel and concrete will limit the vibration transfer, and thus limit sound transmission. Generally, materials that have good vibration transfer are capable of generating audible sounds. Specifically, the vibrations produced by the sonic transducer 100 cause a change in mechanics in the surface in the form of deformation of the surface. The amount of deformation is based upon the laws of acoustics including Young's Modulus, the density of the surface, the shape of the surface and the resonance of the surface.

According to the invention, a thin sheet of glass is an excellent surface for generating sounds using the sonic transducer 100 of the invention. On the other hand, a cube of steel would not provide a good surface for sound generation. An additional example of a suitable surface for the sonic transducer 100 of the invention may comprise the wall of a residential home. The amplitude of a large vibration plane such as a large wall is small, whereas the vibration volume is large. Of course, low pitch sounds require a higher vibration volume, making a conventional wall a suitable surface for generating sound. Alternatively, a suitable vibration volume may be created using a planar surface of an object comprising a soft malleable material having a small area, wherein the material is soft enough to create large amplitude, thereby creating a suitable vibration volume.

In accordance with the principles of the invention, The sonic transducer 100 is placed on the surface such that protective pad 142 is disposed between the housing 102 and the surface, to prevent scratching or other damage to the surface. The vibration strain generated by the sonic transducer 100 is transferred to the surface, which in turn vibrates the ambient air and generates audible sound waves. As set forth hereinabove, the sonic transducer 100 of the present invention is a vibrating source rather than a speaker that generates audible sound. In particular, the sonic transducer 100 does not include a diaphragm (or a cup or plate) to help generate sound that may be heard by a human. Instead, the sound generated by the vibration of the sonic transducer 100 cannot be effectively heard by a human without the use of a surface or medium as set forth in the preceding paragraph.

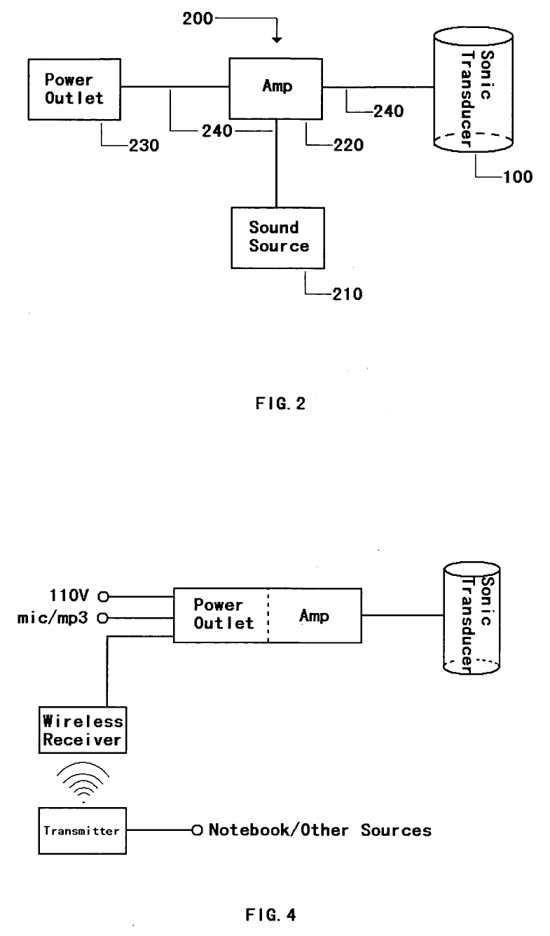

Referring to FIG. 2, an exemplary sound system 200 employing the sonic transducer 100 of the invention will now be described. Specifically, the sound system 200 comprises a sound source 210, an amplifier 220, a sonic transducer 100, and a power outlet 230. The sound source 210, amplifier 220, sonic transducer 100, and power outlet 230 may be interconnected using suitable conventional electrical wiring 240, as is per se known in the art. Alternatively, these components may be interconnected wirelessly, for example using BLUETOOTH wireless technology. In the sound system 200 of FIG. 2, the sound source 210 may comprise without limitation a computer, a DVD player, a CD player, an MP3 player or an FM receiver, wherein the sonic transducer 100 is provided in lieu of a conventional point sound source such as a speaker. Specifically, the sonic transducer 100 broadcasts sound by causing the surface which it is in contact with to vibrate and act as a surface sound source, thereby producing audible sounds with an increased effective range. In this manner, the sonic transducer 100 may be employed to broadcast sound such that the sounds heard at various distances from the sonic transducer 100 are most identical. According to some embodiments, the sound system 200 may be configured to generate “high” versus “low” sounds on the spectrum. In particular, the sound system 200 may feature multiple sonic transducers 100, wherein each transducer 100 is structured to produce various sounds. In this manner, the sound system 200 may be used to deliver stereo or surround sound capabilities.

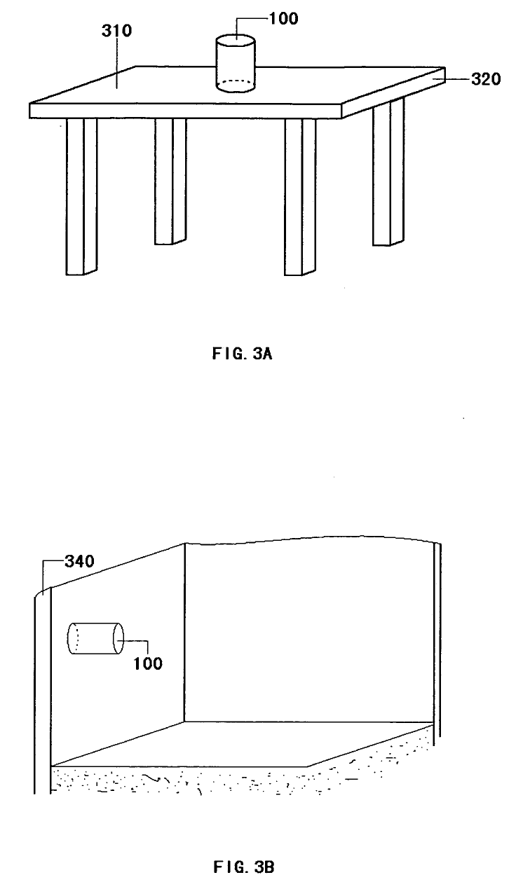

Referring to FIG. 3A, in an exemplary embodiment, the sonic transducer 100 of FIG. 1 is placed on the top surface 310 of a table 320. In this embodiment, the weight of the sonic transducer 100 (particularly, the weighted outer core 134) results in substantially continuous contact between the vibrating device and the table 320. In particular, the vibration energy in the electromagnet 124 is channeled onto the top surface 310 of the table 320 via the energy channeler 130. This embodiment of the sonic transducer 100 may be used in conjunction with a telephony system to form an office conference call system, wherein the sonic transducer may positioned at any location on the top surface of the table 320, wherein everyone in the room can hear the broadcast with similar clarity and volume. Since audible sound is being transferred by a larger surface (as compared with traditional speakers), it is more likely that the volume level of the sound can be adjusted to better match the comfort level of everyone in a large room. By contrast, people that are located closer to a conventional speaker are expected to bear with a louder volume so those farther from the speaker can hear the sound transmission.

According to a further embodiment of the invention, the sonic transducer may not include a weighted outer core. Instead, the sonic transducer may be selectively coupled with one or more weighted base units. By way of example, a home owner may place a plurality of weighted base units at predetermined positions around the house, and may carry the “light weight” sonic transducer from one docking station to another. Similarly, this embodiment may be employed in commercial settings as well, such as in a coffee shop, restaurant, or ice cream store.

Referring to FIG. 3B, in another exemplary embodiment, the sonic transducer 100 of FIG. 1 is attached to a vertically disposed surface 340 such as a pane of glass or a wall. For example, the sonic transducer 100 may be attached to one side of the vertically disposed surface 340 such that sound may be broadcast on both sides of the vertically disposed surface 340 simultaneously. In other words, a single device can allow a coffee shop (or ice cream store, etc.) to broadcast music or other sounds to both their indoor and outdoor patrons. Similar to the exemplary embodiment of FIG. 3A, the vibration energy in the electromagnet 124 is channeled onto the vertically disposed surface 340 via the energy channeler 130. This embodiment of the sonic transducer 100 may be particularly useful for broadcasting sound through both sides of a glass pane, for example a coffee shop.

Referring to FIG. 4, a preferred sound system 400 employing the sonic transducer 100 of the invention will now be described. In particular, the sound system 400 comprises a sound source 410 including a transmitter (e.g., a notebook computer), a wireless receiver 415 for receiving sound waves from the wireless sound source 410, a combined amplifier/power source 420 disposed in a single black box, and sonic transducer 100. Although the sound source 410 is depicted as a notebook computer, it should be appreciated by one of ordinary skill in the art that other sound sources such as DVD players, CD players, MP3 players and FM receivers may be employed without departing from the scope of the invention. The sonic transducer 100 is provided in lieu of a conventional point sound source such as a speaker. Particularly, the sonic transducer 100 broadcasts sound by causing the surface which it is in contact with to vibrate and act as a surface sound source, thereby producing audible sounds with an increased effective range. In this manner, the sonic transducer 100 may be employed to broadcast sound such that the sounds heard at various locations in the room are almost identical. In addition, the sound system 400 may be configured to generate “high” versus “low” sounds on the spectrum. Moreover, the sound system 400 may feature multiple sonic transducers 100, wherein each transducer 100 is configured to produce various sounds, to deliver stereo or surround effect capabilities.

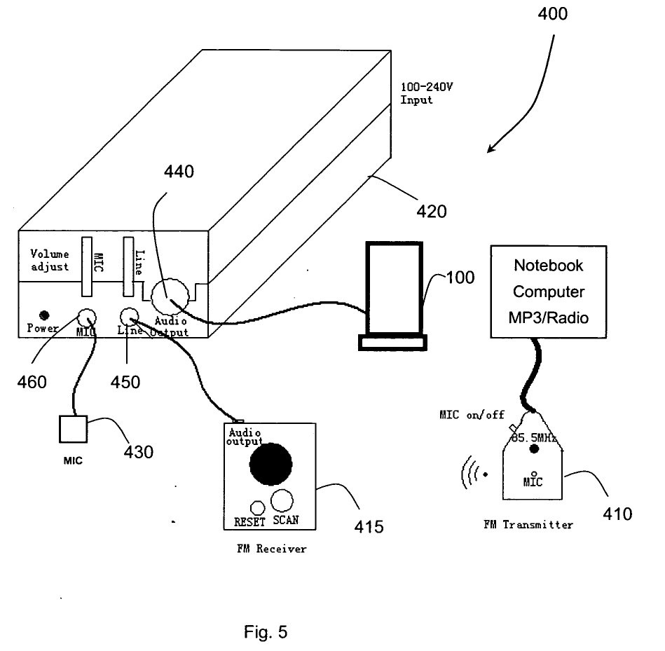

FIG. 5 is a perspective view illustrating the preferred sound system 400 of FIG. 4 including the sound source 410 (FM transmitter), the wireless receiver 415 (FM receiver), the combined amplifier/power source 420, the sonic transducer 100, and a microphone 430. In addition to an AC outlet (not shown), there are 3 connected ports at one side of the black box including an audio output port 440 for connection of the sonic transducer 100, a line port 450 for connection to the wireless receiver 415, and a MIC port 460 for connection of the microphone 430. By way of example, the line port 450 may be connected directly to a notebook computer or an MP3 ear phone plug, or the line port 450 may be connected to an FM Receiver, and then to a notebook computer or an MP3 ear phone plug. According to additional embodiments of the invention, the FM wireless transmitter and receiver can be replaced with a 900 MHz chipset, a 2.4 GHz chipset, or BLUETOOTH technology.

According to a further embodiment of the invention, the amplifier, power outlet, and wireless receiver may be disposed inside of the sonic transducer housing. In addition, the combined amplifier/power source 420 may include a USB port, as the power source and earphone port. According to an additional embodiment of the invention, the microphone function and RJ 11 or RJ 45 ports may be integrated into the wireless transmitter that connects to the earphone port. Additionally, the sonic transducer 100 may be battery operated such that it does not require a power cord. For example, the transducer 100 may employ AA or AAA batteries, or a Lithium battery.

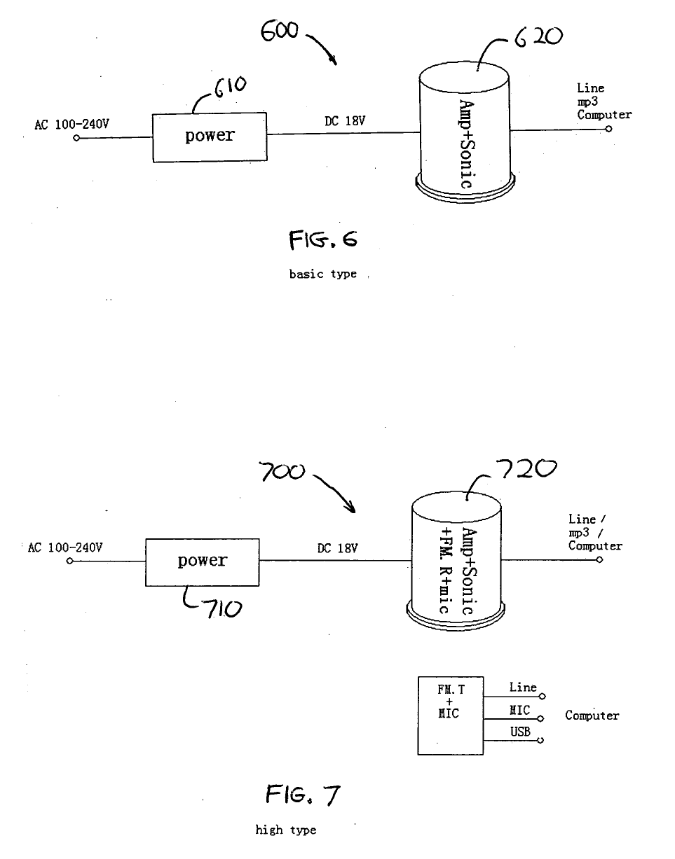

FIGS. 6-8 are functional diagrams depicting alternative functional configurations of the sound system of the present invention to be employed in different consumer and business application. In any of these system configurations, one or more rechargeable batteries may be implemented into the sonic transducer such that the device is portable and wireless in both power and communication. FIG. 6 is a functional diagram of a basic sound system configuration 600 including a power source 610 and a sonic transducer 620, similar to the preferred sonic transducer 100 described hereinabove, but further comprising an internal amplifier. In the illustrated embodiment, the power source 610 comprises an individual box having an input (e.g., AC100-240V) and an output (e.g., 12V2 A) connected to the sonic transducer 620, which includes a line-in connecting the device to a sound source such as a computer, a DVD player, a CD player, an MP3 player or an FM receiver. According to the invention, the sound source may include volume, high pitch, and bass controls for adjusted these sound parameters.

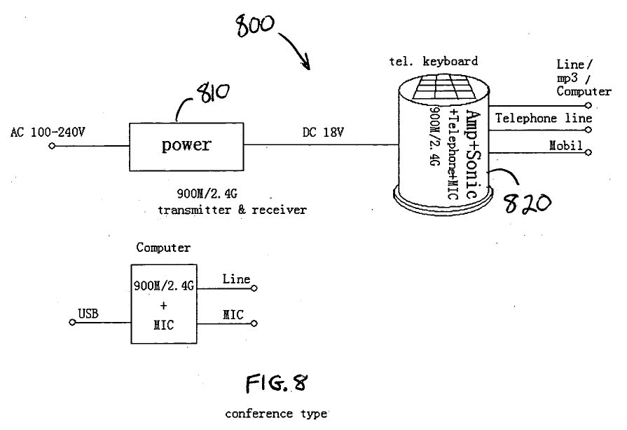

FIG. 7 is a functional diagram of a high type sound system configuration 700 including a power source 710 and a sonic transducer 720, similar to the preferred sonic transducer 100 of FIG. 1, but further comprising an internal amplifier, a wireless transmitter/receiver with microphone including a volume control. Similar to the previous embodiment, the power source 710 is an individual box having an input (e.g., AC100-240V) and an output (e.g., 12V2 A) connected to the sonic transducer 720, which again includes a line connecting the device to a sound source such as a computer, a DVD player, a CD player, an MP3 player or an FM receiver. By way of example, the wireless transmitter/receiver may comprise an FM/900 MHz/2.4 GHz wireless transmitter/receiver which employs a rechargeable battery that can be recharged through a USB port of the computer. In the illustrated embodiment, the sonic transducer 720 also includes a USB connector, a line-in connector, and a microphone connector.

FIG. 8 is a functional diagram of a conference call sound system configuration 800 including a power source 810 and a sonic transducer 820, similar to the preferred sonic transducer 100 of the invention, but further comprising an internal amplifier, a wireless transmitter/receiver with microphone, and a telephone set. The power source 810 includes an input (e.g., AC100-240V) and an output (e.g., 12V2 A) connected to the sonic transducer 820, which again includes a line connecting the device to a sound source such as a computer, a DVD player, a CD player, an MP3 player or an FM receiver. By way of example, the wireless transmitter/receiver may comprise an FM/900 MHz/2.4 GHz wireless transmitter/receiver that may be configured for conference calls, such as via using a computer. The wireless transmitter/receiver can be recharged through the USB port of the computer. The sonic transducer 820 further includes a USB connector, a line-in connector, a microphone connector, and a telephone connector. For example, an RJ-75 telephone jack and/or a cellular phone jack may be implemented to receive telecommunication signals. In addition, the sonic transducer 820 may be provided with a telephone keypad. The line-in connector transmits sound from the sound source to the sonic transducer 820, while the microphone connector transmits the sound from sonic transducer 820 to the sound source.

One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well. Therefore, the present invention should not be seen as limited to the forms shown, which is to be considered illustrative rather than restrictive.

What is claimed is:

1. A device, comprising:
an outer shell;
a permanent magnet disposed within the outer shell;
an electromagnet disposed within the outer shell;
a coil for carrying an electrical current, wherein the coil is wrapped around the electromagnet to induce vibration in the electromagnet; and
an energy channeler for channeling vibration energy from the electromagnet onto a surface that is in contact with the device,
wherein the surface becomes a surface sound source.

2. The device of claim 1, wherein the device further comprises a weighted outer core.

3. The device of claim 1, further comprising a protective pad attached to a bottom surface of the device to prevent scratching of the surface which the device is in contact with.

4. The device of claim 1, wherein the device is powered using an alternating current that induces vibration in the electromagnet.

5. The device of claim 1, wherein the surface is a horizontally disposed surface.

6. The device of claim 5, wherein the device is weighted to cause the device to be closely adhered to the horizontally disposed surface.

7. The device of claim 1, further comprising a protective pad disposed between the permanent magnet and the electromagnet to prevent contact therebetween.

8. The device of claim 1, wherein an electrical field generated in the coil causes mechanical changes in the material that make up the electromagnet.

9. The device of claim 1, wherein the electromagnet comprises a high magnetostrictive material having an alloy core including one or more Rare Earth materials.

10. The device of claim 1, wherein the electromagnet comprises materials selected from the group consisting of: piezoelectric materials; piezomagnetic materials; electrostrictive materials; and magnetostrictive materials.

11. The device of claim 1, wherein the surface comprises a table, glass or wall that provides suitable sound transmission characteristics.

12. The device of claim 1, wherein the surface comprises wood or glass.

13. The device of claim 1, wherein the device is used in conjunction with a telephony system to form a conference call system.

14. The device of claim 1, wherein:
the surface is a vertically disposed surface; and
the device is attached to one side of the vertically disposed surface such that sound may be broadcast on both sides of the vertically disposed surface simultaneously.

15. The device of claim 14, wherein the vertically disposed surface comprises a pane of glass.

16. A sound system, comprising:
a sound source;
an amplifier;
a power outlet; and
a device, comprising:
an outer shell;
a permanent magnet disposed within the outer shell;
an electromagnet disposed within the outer shell;
a coil for carrying an electrical current, wherein the coil is wrapped around the electromagnet to induce vibration in the electromagnet; and
an energy channeler for channeling vibration energy from the electromagnet onto a surface that is in contact with the device,
wherein the surface becomes a surface sound source.

17. The sound system of claim 16, wherein the sound source, amplifier, device and power outlet are interconnected using conventional electrical wiring.

18. The sound system of claim 16, wherein the sound source, amplifier, device and power outlet are interconnected wirelessly.

19. The sound system of claim 16, wherein the sound source comprises a computer, a DVD player, a CD player, an MP3 player or an FM receiver.

20. The sound system of claim 16, wherein the device broadcasts sound by causing the surface which it is in contact with to vibrate, producing audible sounds such as music.

21. The sound system of claim 16, wherein the device further comprises an internal amplifier, a wireless transmitter/receiver with microphone, and a telephone set.
